(19) United States
(12) Patent Application Publication
(10) Pub. No.: US 2004/0204195 A1
(43) Pub. Date: Oct. 14, 2004

(54) Cell phone having improved construction

(76) Inventor: Stanley Barker, Philadelphia, PA (US)

Correspondence Address: ZACHARY T. WOBENSMITH, III, 6091 CARVERSVILLE/WISMER ROAD, P.O. BOX 370, PIPERSVILLE, PA, 18947-0370, US

(21) Appl. No.: 10/307,582

(22) Filed: Dec. 2, 2002

(51) Int. Cl. H04B 1/38; H04M 1/00

(52) U.S. Cl. 455/575.1; 455/550.1; 455/90.1

(57) ABSTRACT

A cell phone for use in making and receiving telephone calls which uses a Piezo transducer as an earphone.

### BACKGROUND OF THE INVENTION

1. Field of the Invention

A cell phone of improved construction which has a Piezo transducer earphone.

2. Description of the Prior Art

The proliferation of analog cell phones with magnetic transducer ear phones, has resulted in increased interest in the possibility that their use can result in increased numbers of brain tumors as a result of the radio frequency (RF) waves generated during their use.

It is known that the magnetic transducers in cell phones produce a magnetic force field which can be detected.

It is thought that the ear phone magnetic force field resonates with the cell phones radio transmission force fields, and the earth's field magnetic ambient, which may affect the user's brain cells and may cause cancer.

Various studies of the effects of radiation on cells have been conducted such as those by Dr. Reba Goodman, Department of Pathology, Columbia University Health Sciences, New York, N.Y., That include effects ranging from increased enzyme reaction rates to increased transcript levels for specific genes.

While the effects of the RF waves generated by cell phones on the brain cells of the user are debated, the generation of these waves is not disputed.

Various proposals for shielding users from RF waves have been considered, however, none of them solve the problem, Examples of patents that relate to the subject matter are U.S. Pat. Nos. 6,109,530; 6,134,336; 6,058,315; 6,144,861; 5,201,069; 4,626,729; 4,597,099; 6,134,336; and 6,109,530.

The improved cell phone construction of the invention uses a Piezo transducer as its earphone, which eliminates RF waves and provides other positive advantages,

### SUMMARY OF THE INVENTION

It has now been found that an improved cell phone which eliminates the magnetic force field generated by the magnetic transducer ear phone of the cell phone is obtained by using a Piezo transducer ear phone.

The principal object of the invention is to provide improved cell phone construction, which eliminates the magnetic force field effect of magnetic transducers by using Piezo transducers as the cell phones' ear phone.

A further objective of the invention is to provide improved cell phone construction which is simple and inexpensive to construct.

A further object of the invention is to provide improved cell phone construction which lends itself to mass production.

A further object of the invention is to provide improved cell phone construction that can be used with old or new cell phones.

Other objects and advantageous features of the invention will be apparent from the description and claims.

### DESCRIPTION OF THE DRAWINGS

The nature and characteristic features of the invention will be more readily understood from the following description taken in connection with the accompanying drawings forming part hereof in which;

FIG. 1 is a pictorial view of a conventional cell phone;

FIG. 2 is a view similar to FIG. 1 illustrating a cell phone embodying the improved construction of the invention;

FIG. 3 is a pictorial view showing a representation of the magnetic wave form generated by a conventional cell phone;

FIG. 4 is a view similar to FIG. 3 showing the lack of magnetic waves from a cell phone constructed in accordance with the invention, and;

FIG. 5 is a pictorial diagram of apparatus for detecting the electromagnetic background and electromagnetic fields, present, and emanating from a cell phone.

It should, of course, be understood that the description and drawings herein are merely illustrative and that various modifications, combinations and changes can be made in the structures disclosed without departing from the spirit of the invention.

### DESCRIPTION OF THE PREFERRED EMBODIMENT

When referring to the preferred embodiment, certain terminology will be utilized for the sake of clarity. Use of such terminology is intended to encompass not only the described embodiment, but also technical equivalents which operate and function in substantially the same way to bring about the same result.

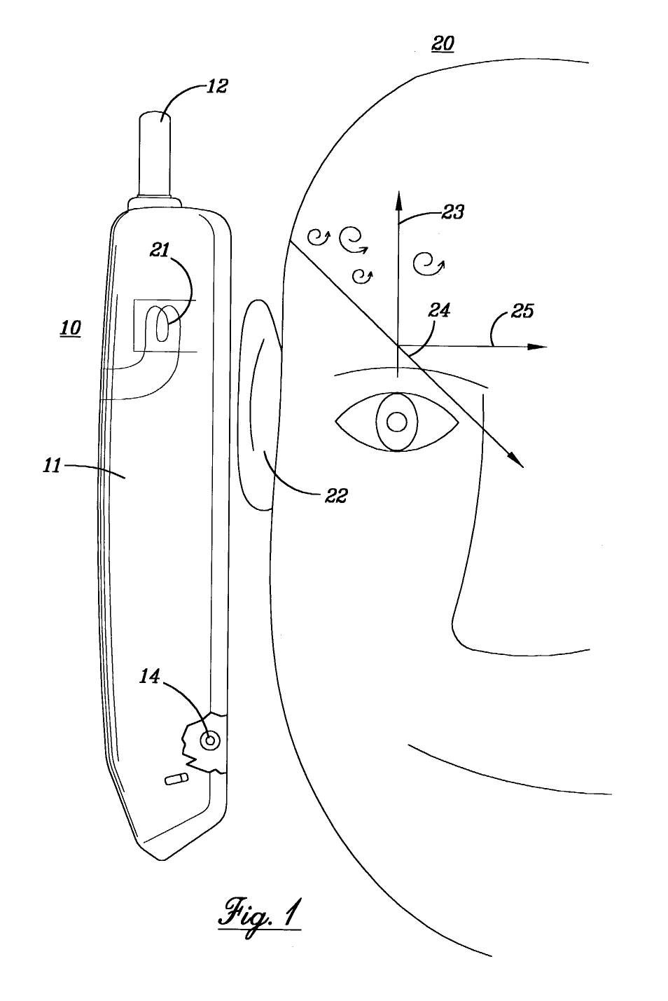

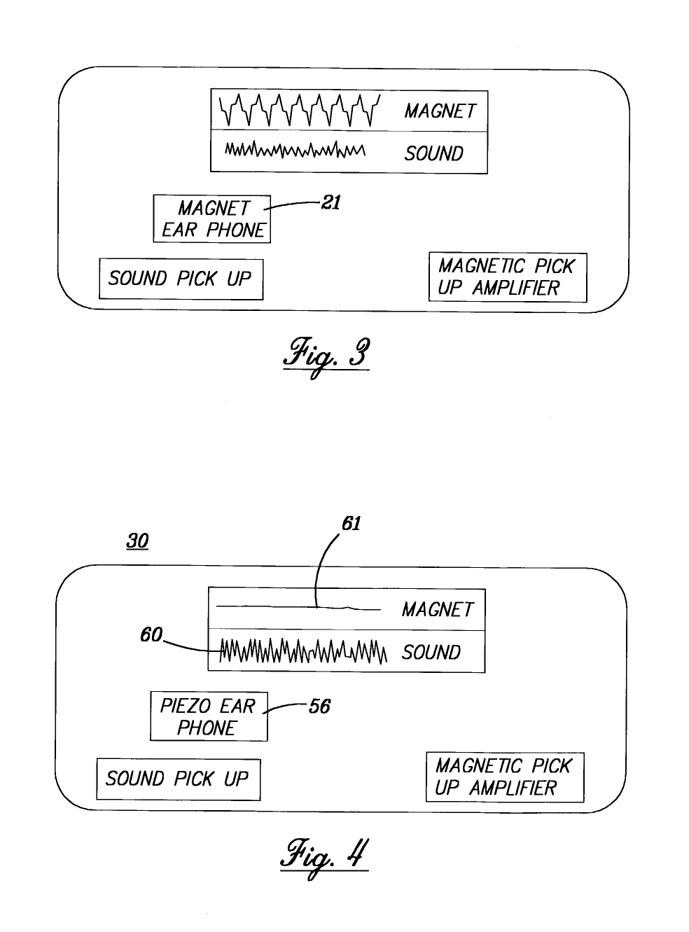

Referring now more particularly to the drawings and FIGS. 1 and 3 thereof a cell phone 10 is therein illustrated, which has an outer housing 11, an antenna 12 and a Piezo microphone 14. The cell phone 10 also includes conventional enabling electrical circuitry (not shown) and a battery (not shown). The cell phone 10 is shown adjacent the head 20 of a user, with an earphone 21 of the magnetic transducer type adjacent the ear 22 of the user.

The earth ambient electromagnetic field present at the users location is indicated by arrow 23, and the modulated cell phone radio frequency electromagnetic field produced by use of the cell phone 10 is indicated by arrow 24. The magnetic modulated electromagnet field emitted by the magnetic earphone 21 of the cell phone is indicated by arrow 25 and travels directly into the brain cells (not shown) of the user.

Referring to FIG. 5, the electromagnetic waves present in the space around the user, ambient as well as emitted waves from the use of the cell phone, are detected by an apparatus 26 of well known type and recorded on an oscilloscope 30. As shown in FIG. 3, the audio wave form 31 is shown adjacent the bottom of the oscilloscope 30, and the magnetic electromagnetic wave form 32 is shown adjacent the top of the oscilloscope. The magnetic wave form 32 is the result of the modulated electromagnetic field emitted by the earphone 21, and the effect on it by the ambient electromagnetic field present around the user. The resultant wave form 32 is thought to have a harmful effect on the user's brain cells, the results of which are still being investigated.

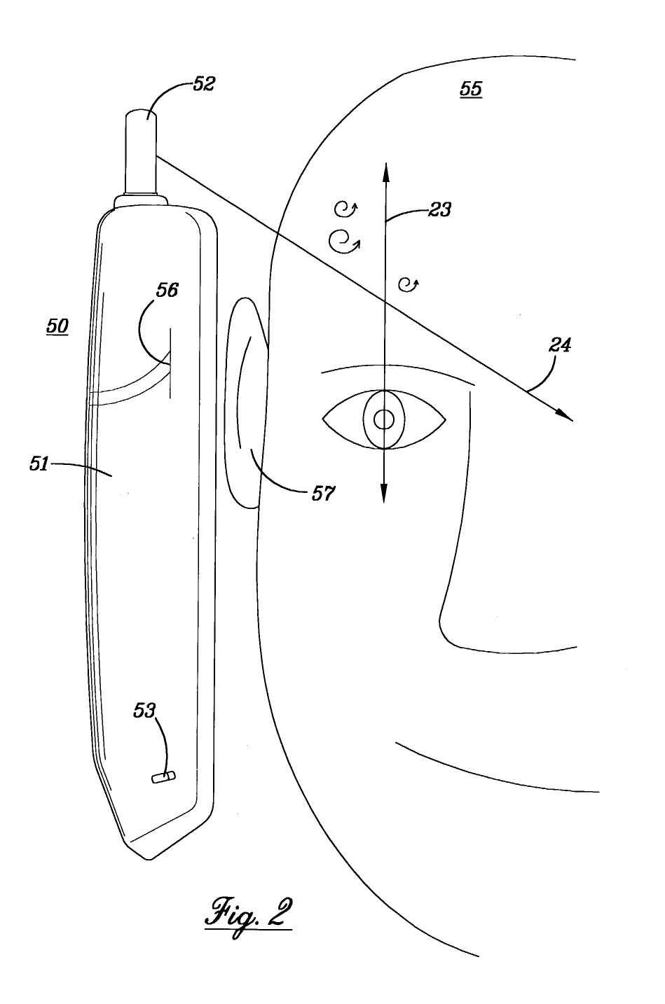

Referring now to FIGS. 2, 4 and 5, a cell phone 50 is therein illustrated. The cell phone 50 is of similar overall construction to that of cell phone 10, with an outer housing 51, an antenna 52 and a Piezo microphone 53. The cell phone 50 also includes conventional electric enabling circuitry (not shown) and a battery (not shown).

The cell phone 50 is shown adjacent the head 55 of a user, with an ear phone 56 adjacent the ear 57 of the user. The earth ambient electromagnetic field is indicated by arrow 23, and the modulated cell phone radio frequency electromagnetic field is indicated by arrow 24.

The earphone 56 is a Piezo transducer of well-known type such as #40-1218-ceramic bimorph driver element available from Radio Shack.

While the earphone 56 is illustrated inside the cell phone housing, it could also be of the auxiliary or plug-in type.

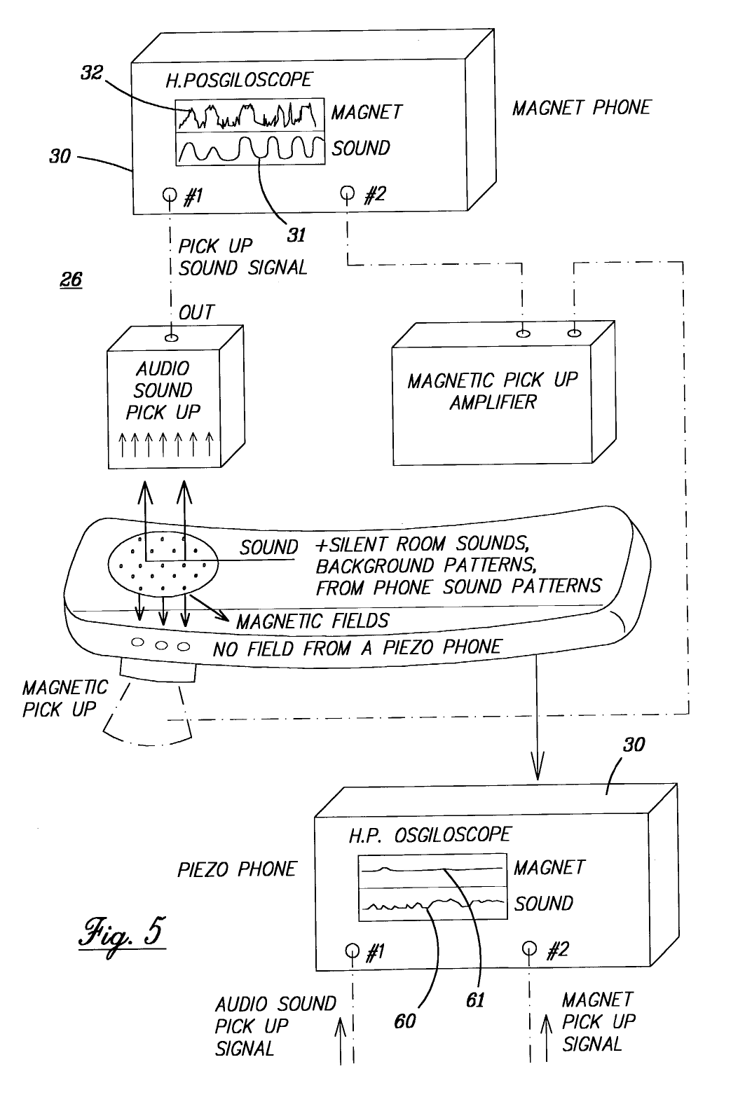

Referring to FIG. 4 the audio wave form 60 detected by apparatus 26, is shown adjacent the bottom of oscilloscope 30, and the wave form 61 that would result from the Piezo transducer earphone 56 is shown as a flat line, indicating that no electromagnetic field was emitted by the Piezo transducer earphone 56.

It will thus be seen that improved cell phone construction has been provided with which the objects of the invention are achieved.

1. A cell phone for use in making and receiving telephone calls, having an outer case, an antenna, a Piezo transducer microphone, enabling electrical circuitry and a battery, the improvement which comprises;
a piezo transducer earphone.

2. A cell phone as defined in claim 1 in which,
said earphone is integral to and inside said outer case.

3. A cell phone as defined in claim 1 in which,
said ear phone is external to said outer case.
